(19) United States
(12) Patent Application Publication
(10) Pub. No.: US 2017/0310131 A1
(43) Pub. Date: Oct. 26, 2017

(54) COLLECTIVE CHARGER FOR TERMINAL DEVICES, AND METHOD FOR CHARGING TERMINAL DEVICES

(71) Applicant: NEC Platforms, Ltd., Kawasaki-shi, Kanagawa (JP)

(72) Inventor: Naoki YASUTAKE, Kanagawa (JP)

(73) Assignee: NEC Platforms, Ltd., Kawasaki-shi, Kanagawa (JP)

(21) Appl. No.: 15/517,992

(22) PCT Filed: Jul. 21, 2015
(86) PCT No.: PCT/JP2015/003637

§ 371 Date: Apr. 10, 2017

(30) Foreign Application Priority Data
Oct. 21, 2014 (JP) 2014-214210

(51) Int. Cl. H02J 7/00

(52) U.S. Cl. CPC H02J 7/0026; H02J 7/0045

(57) ABSTRACT

Provided is a collective charger for a terminal device, which is configured to display a remaining battery level of a rechargeable battery-driven terminal device so that a user can visually recognize the remaining battery level easily and quickly. The collective charger for a terminal device according to this invention includes: a plurality of terminal receiving portions (101-1 to 101-5) capable of receiving a plurality of terminal devices, respectively; a power source unit configured to supply electric power for charging to one or a plurality of terminal devices each received in corresponding one of the plurality of terminal receiving portions (101-1 to 101-5); and a plurality of state-of-charge display portions (103-1 to 103-5) arranged correspondingly to the plurality of terminal receiving portions (101-1 to 101-5), respectively, and each configured to display a state of charge of a battery including a remaining battery level of each terminal device received in a corresponding terminal receiving portion.

### TECHNICAL FIELD

This invention relates to a collective charger capable of charging a plurality of rechargeable battery-driven terminal devices.

### BACKGROUND ART

As a self-ordering system applied to a restaurant or other stores, there is known an operation form as below A collective charger, which is used for a plurality of self-ordering terminal devices (hereinafter, in some cases, abbreviated as terminal devices) each including a rechargeable battery as a power source, is arranged around the cash register near the entrance to the store. A staff who guides an entering customer to the table, or a staff who has finished guiding a customer to the table picks up a terminal device from the collective charger. Then, the staff passes and lends the terminal device to the customer at each table, and the customer at each table, for example, places an order by himself or herself using the terminal device.

The self-ordering terminal device has, for example, a plate-like shape, that is, a pad-like shape or a tablet terminal shape. The self-ordering terminal device includes a touch panel display being a type of a user interface, a communication portion for communication to/from a Point Of Sales (POS) server, and a rechargeable battery as a power source.

Meanwhile, the collective charger can receive the plurality of self-ordering terminal devices similarly to a bookshelf receiving a plurality of books, and is configured to charge one or more received self-ordering terminal devices.

Here, when the self-ordering terminal device is lent to the customer, the battery of the self-ordering terminal device is required to be sufficiently charged so as to prevent an out-of-battery state during use by the customer. A remaining battery level is displayed on a display portion of the terminal device, and hence the staff or the customer can recognize the remaining battery level by visually recognizing the display portion.

The self-ordering system including the collective charger is disclosed in, for example, Patent Document 1. One object of the self-ordering system disclosed in Patent Document 1 is to solve a problem of high cost when a charger for the self-ordering terminal device is arranged on each table. In the self-ordering system, the POS server is configured to obtain the remaining battery levels of the plurality of self-ordering terminal devices, which are received in the collective charger and are being charged, and to select the terminal device having the largest remaining battery level to display the terminal device on a reception terminal.

### PRIOR ART DOCUMENTS

### Patent Document

Patent Document 1: JP-A-2014-002652

### DISCLOSURE OF THE INVENTION

### Problem to be Solved by the Invention

In general, when the self-ordering terminal device is received in the collective charger to be charged, the touch panel display of the terminal device is designed so that a backlight or a display function itself of the display is suspended for the purpose of saving electricity.

Thus, when the touch panel display also serves as the above-mentioned display portion of the remaining battery level, the staff cannot recognize the remaining battery level until the staff picks up the terminal device from the collective charger or performs an operation of canceling the suspend state of the terminal device received in the collective charger in order to cancel the suspend state of the touch panel display.

Further, even when the remaining battery level of the terminal device can be displayed through the operation of canceling the suspend state while the terminal device is received in the collective charger, the staff needs to look into the display from a clearance secured with respect to an adjacent terminal device and has a difficulty in visually recognizing the remaining battery level because the plurality of terminal devices are generally received in the collective charger as if the plurality of books are arranged side by side.

Alternatively, even when the terminal device includes a display portion dedicated to display of the remaining battery level, which is called a charging lamp, for example, on a side surface of the terminal device separately from the touch panel display, it is difficult for the staff to quickly recognize the charging lamp, which is arranged at the same position of the adjacent terminal device, because the plurality of terminal devices are generally received in the collective charger as if the plurality of books are arranged side by side. Further, for the purpose of downsizing, thinning, lightweighting, and cost reduction of the terminal device, the charging lamp is generally constructed by a single light emitting element capable of multicolor or blinking light emission, and generally indicates a state of charge of the battery through the light emission color or continuous/blinking light emission of the light emitting element. Thus, it is further difficult for the staff to quickly recognize the specific remaining battery level.

When the staff cannot quickly recognize the remaining battery level as described above, operations, which require quick customer service, are hindered, and hence an improvement thereof is desired.

Accordingly, it is an object of this invention to provide a. collective charger for a terminal device, which is configured to display a remaining battery level of a rechargeable battery-driven terminal device so that a user can visually recognize the remaining battery level easily and quickly.

### Means to Solve the Problem

According to this invention, there is provided a collective charger, comprising a plurality of terminal receiving portions capable of receiving a plurality of terminal devices, respectively; a power source unit configured to supply electric power for charging to one or a plurality of terminal devices each received in corresponding one of the plurality of terminal receiving portions; and a plurality of state-of-charge display portions arranged correspondingly to the plurality of terminal receiving portions, respectively, and each configured to display a state of charge of a battery including a remaining battery level of each terminal device received in a corresponding terminal receiving portion.

According to this invention, there is also provided a method of charging a terminal device, comprising the steps of receiving one or a plurality of terminal devices, the plurality of terminal devices being arranged in parallel when a plurality of terminal devices are received; supplying electric power for charging to the received one or plurality of terminal devices; and displaying a state of charge of a battery including a remaining battery level of each of the received one or plurality of terminal devices at a position corresponding to each terminal device.

### Effect of the Invention

According to this invention, there can be obtained the collective charger for a terminal device, which is configured to display the remaining battery level of the rechargeable battery-driven terminal device so that the user can visually recognize the remaining battery level easily and quickly.

### BRIEF DESCRIPTION OF THE DRAWING

FIG. 1 is a perspective view of a self-ordering terminal device being an object to be charged by a collective charger according to a first embodiment of this invention.

FIG. 2 is a perspective view of the collective charger according to the first embodiment of this invention.

FIG. 3 includes views for illustrating a USB terminal and a charging terminal of the collective charger illustrated in FIG. 1, (a) being a plan view, (b) being a side view.

FIG. 4 is a perspective view for illustrating a used state of the collective charger illustrated in FIG. 1.

FIG. 5 includes views for illustrating a display action of a state-of-charge display portion of the collective charger illustrated in FIG. 1, (a) being a view for illustrating the state-of-charge display portion itself, (b) being a view for illustrating display modes of the state-of-charge display portion.

FIG. 6 is a view for illustrating an electric circuit of the collective charger illustrated in FIG. 1.

FIG. 7 is a view for illustrating details of a control it of the collective charger illustrated in FIG. 1.

FIG. 8 is a flowchart for illustrating an operation of the collective charger illustrated in FIG. 1.

FIG. 9 is a view for illustrating an electric circuit of a collective charger according to a second embodiment of this invention.

FIG. 10 is a view for illustrating details of a control unit of the collective charger illustrated in FIG. 9.

FIG. 11 is a flowchart for illustrating an operation of the collective charger illustrated in FIG. 9.

### MODES FOR EMBODYING THE INVENTION

A collective charger for a terminal device according to this invention includes a plurality of terminal receiving portions, a power source unit, and a plurality of state-of-charge display portions.

The plurality of terminal receiving portions can receive a plurality of terminal devices, respectively. The term “receive” in this invention is not limited to a mode of accommodating the terminal device by covering an entire terminal device being an object to be accommodated, and includes a mode of receiving and holding a part of the terminal device.

Further, the power source unit is configured to supply electric power for charging to one or a plurality of terminal devices each received in the terminal receiving portion.

Further, the plurality of state-of-charge display portions are arranged correspondingly to the plurality of terminal receiving portions, respectively. At each of the state-of-charge display portions, there is displayed a state of charge of a battery including a remaining battery level of each terminal device received in the terminal receiving portion.

With the above-mentioned configuration, the collective charger is capable of displaying the remaining battery level of the rechargeable battery-driven terminal device so that a user can visually recognize the remaining battery level easily and quickly.

Now, with reference to the drawings, further detailed description is made of the collective charger for a terminal device, a self-ordering system, and a method of charging a terminal device according to this invention.

### First Embodiment

In the self-ordering system applied to a restaurant and other stores, a collective charger according to a first embodiment of this invention is a device, which is arranged around a cash register near the entrance to the store and is capable of charging a plurality of rechargeable battery-driven self-ordering terminal devices.

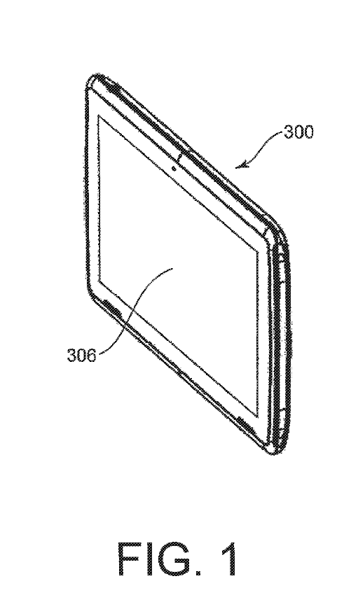

Here, with reference to FIG. 1. a self-ordering terminal device 300 is a portable information processing device having a plate-like shape, that is, a pad-like shape or a tablet terminal shape, and includes a touch panel display 306 as a user input/output interface. Further, although not apparent in FIG. 1, the self-ordering terminal device 300 includes a charging terminal (power-receiving terminal) and a Universal Serial Bus (USB) terminal on a surface being a lower portion in FIG. 1 among side surfaces of the self-ordering terminal device 300. Further, although not apparent in FIG. 1, the self-ordering terminal device 300 includes a wireless communication interface, for example, a secured Wi-Fi (trademark or registered trademark) standard, which is configured to wirelessly communicate order information of menu items input by the customer using the touch panel display 306 after the self-ordering terminal device 300 is lent to the customer at the store to/from a POS server through an access point.

In the collective charger of this invention, a charging circuit is not formed. Meanwhile, as described later, the charging circuit is formed on the terminal device 300 side. Further, the terminal device 300 includes a mechanism (function) that enables the user to recognize a charged and discharged state of the battery.

[Configuration]

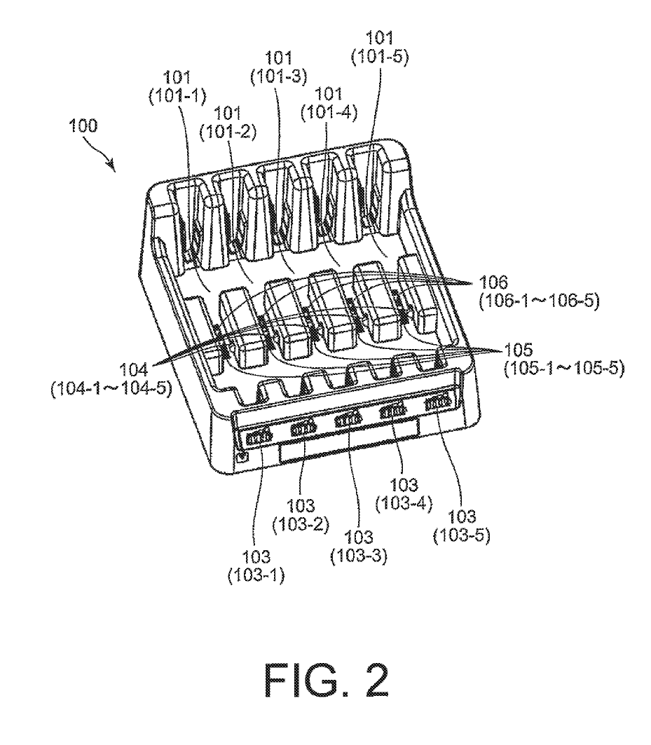

With reference to FIG. 2, a collective charger 100 according to the first embodiment of this invention includes five terminal receiving portions 101 (101-1 to 101-5) as slot-shaped terminal receiving portions, which are formed in a main body of the collective charger 100 and are each for vertically receiving the terminal device 300 when charging is performed.

The collective charger 100 further includes, correspondingly to the five terminal receiving portions 101-1 to 101-5, receiving detection switches 104 (104-1 to 104-5) each configured to detect that the terminal device 300 is placed on, that is, received in the terminal receiving portion 101, charging terminals 106 (106-1 to 106-5) each configured to supply a power supply voltage for charging to the terminal device 300, USB terminals 105 (105-1 to 105-5) each configured to be USB-connected to the terminal device 300 to obtain information of a remaining battery level of the terminal device 300, and state-of-charge display portions 103 (103-1 to 103-5) each configured to display the state of the remaining battery level of the terminal device 300.

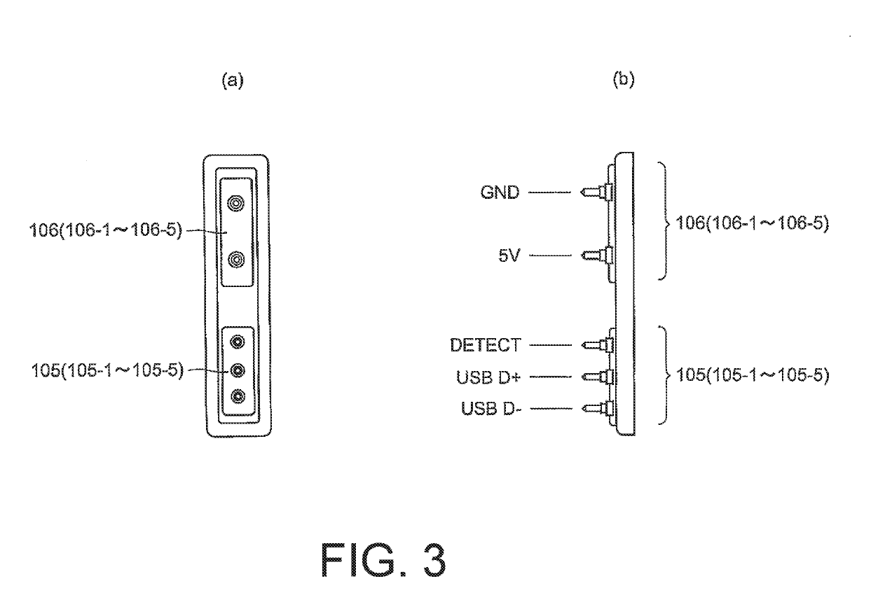

As illustrated in FIG. 3(a) and FIG. 3(b), the charging terminals 106-1 to 106-5 and the USB terminals 105-1 to 105-5 are each a terminal having a pogo-pin (trademark or registered. trademark) type or a probe type. Each of the charging terminals 106-1 to 106-5 and each of the USB terminals 105-1 to 105-5 are constructed so as to contract in an axial direction in a freely returnable manner so that dimensional tolerances of the terminal receiving portions 101-1 to 101-5 of the collective charger 100 and the self-ordering terminal device 300 are absorbed to reliably bring each of the charging terminals 106-1 to 106-5 and each of the USB terminals 105-1 to 105-5 into contact with corresponding terminals arranged on a side surface of the terminal device 300 received in the terminal receiving portion 101.

The charging terminal 106 includes a GND terminal and a 5 V terminal. The USB terminal 105 includes a DETECT terminal, a USB (D+) terminal, and a USB (D−) terminal.

In this embodiment, in the 5 V terminal of the charging terminal 106, a DC voltage of 5 V is on/off controlled by the receiving detection switch 104 and a safety circuit formed of two FETs, which is described later. The GND terminal of the charging terminal 106 is connected to the ground.

Further, the DETECT terminal of the USB terminal 105 has an equal potential to the GND terminal of the charging terminal 106, and is a terminal to be used for detecting that the terminal device 300 is received in, that is, placed on the collective charger 100.

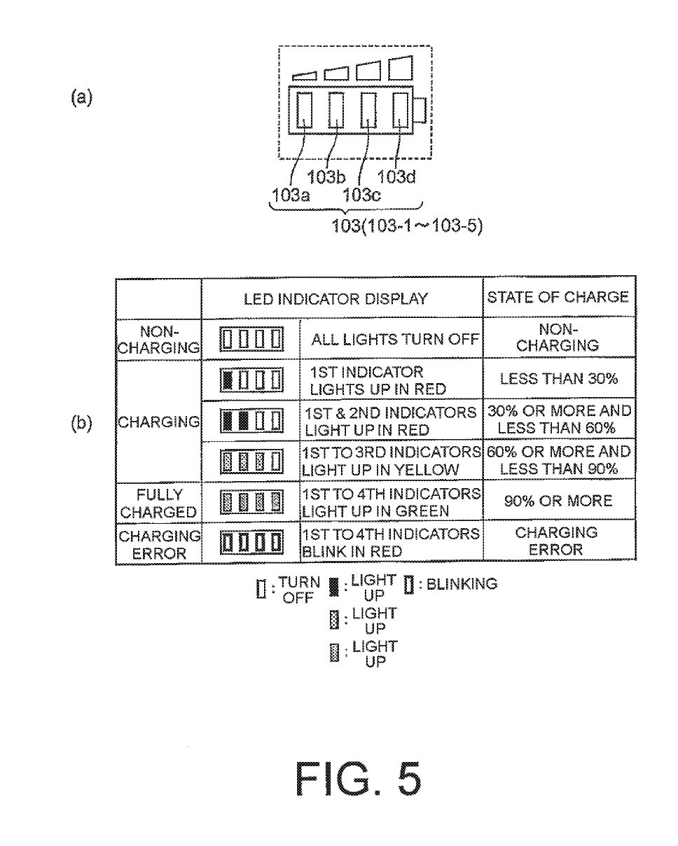

The user (mainly a staff) can intuitively recognize a correspondence between the state-of-charge display portions 103 and the terminal receiving portions 101 because the state-of-charge display portions 103-1 to 103-5 are each arranged on an extending line of the terminal receiving portion 101. As illustrated in FIG. 5(a) and FIG. 5(b), the state-of-charge display portion 103 further includes a first indicator 103a, a second indicator 103b, a third indicator 103c, and a fourth indicator 103d as a plurality of display segments so that the remaining battery level, that is, a battery capacity of the rechargeable battery of the terminal device 300 can be graphically displayed at four levels. In this embodiment, respective indicators are constructed by laser emitting diode (LED) elements capable of light-emitting in multicolor. A state of the remaining battery level of the terminal device 300 may be displayed using a liquid crystal display (LCD) instead of the LED indicators

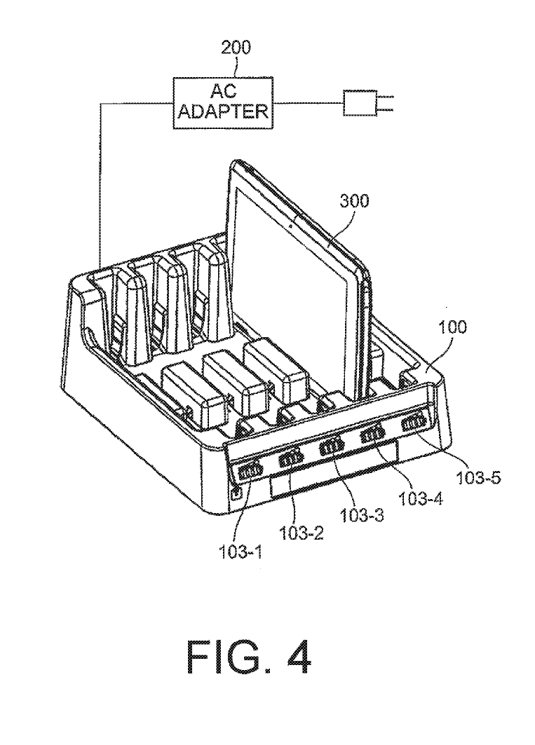

FIG. 4 is an illustration of a state in which one of the terminal devices 300 is received in the terminal receiving portion 101-4 of the collective charger 100. As illustrated in FIG. 4, electric power is fed to the collective charger 100 by an AC adapter 200 to be connected to a commercial power supply outlet of the store.

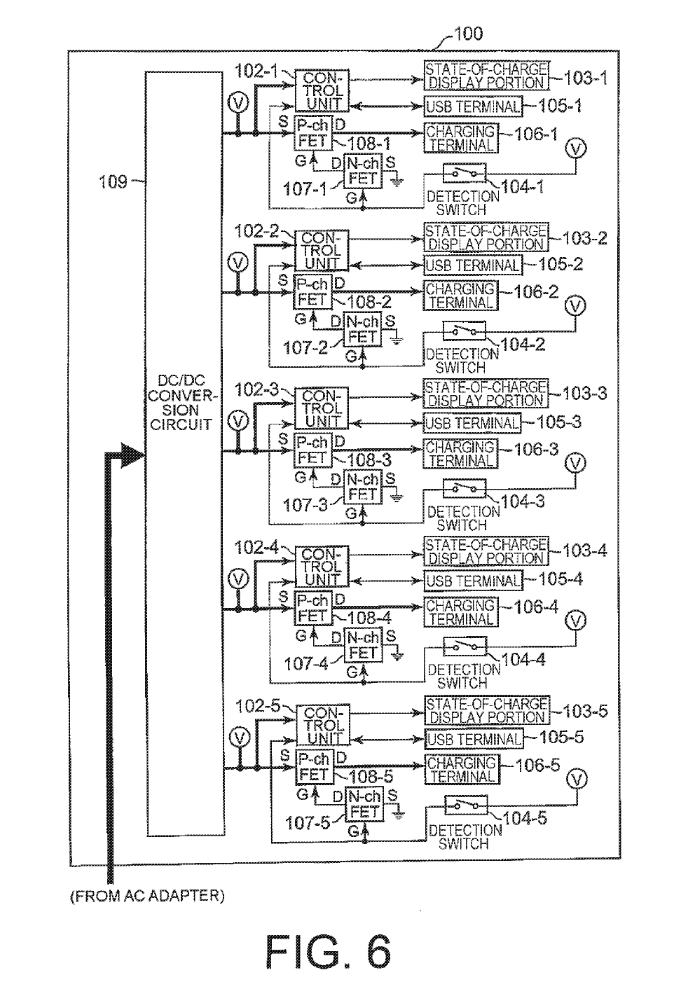

With reference to FIG. 6 for illustrating a circuit configuration, the collective charger 100 includes control units 102 (102-1 to 102-5). The control units 102 are configured to obtain states of charge of the batteries from the respective terminal devices received in the terminal receiving portions 101-1 to 101-5 illustrated in FIG. 2, to thereby control the state-of-charge display portions 103-1 to 103-5 illustrated in FIG. 2 to display the states of charge of the batteries based on the obtained states of charge of the batteries.

The collective charger 100 further includes a DC/DC conversion circuit 109. The DC/DC conversion circuit 109 is configured perform voltage conversion of a DC power supply voltage supplied from the AC adapter 200 illustrated in FIG. 4, which is a voltage of 19.5 V in this embodiment and is indicated by the thickest solid line in FIG. 6, to thereby supply power supply for charging for the terminal device 300, which is a voltage of 5 V in this embodiment and is indicated by the second thickest line in FIG. 6, and power supply for operation of the collective charger 100 itself, which is a voltage of 5 V in this embodiment.

The collective charger 100 further includes a plurality of receiving detection switches 104 (104-1 to 104-5) configured to detect whether or not the terminal receiving portions 101-1 to 101-5 which are illustrated in FIG. 2 receive the terminal devices 300.

The control units 102 (102-1 to 102-5) are in a reset state when the terminal devices 300 are not received in the terminal receiving portions 101-1 to 101-5, whereas the reset state is canceled when the terminal devices are received in the terminal receiving portions 101-1 to 101-5. The difference is caused by the following configuration. Each of the control units 102 includes a reset terminal, and the reset terminal is switched from Low to High with the receiving detection switch 104 being pushed while the terminal device 300 is received in the terminal receiving portion 101. Meanwhile, when the terminal device 300 is not received in the terminal receiving portion 101, the receiving detection switch 104 is not pushed and the reset terminal is not switched to High, with the result that the reset terminal is maintained to be Low.

The collective charger 100 further includes the safety circuit formed of an N channel field effect transistor (FET) 107 and a P channel FET 108, which is configured to prevent a voltage of 5 V of electric power for charging from being generated at the charging terminal 106 corresponding to the terminal receiving portion based on the detection signal of the receiving detection switch when the terminal device 300 is not received in the terminal receiving portion 101.

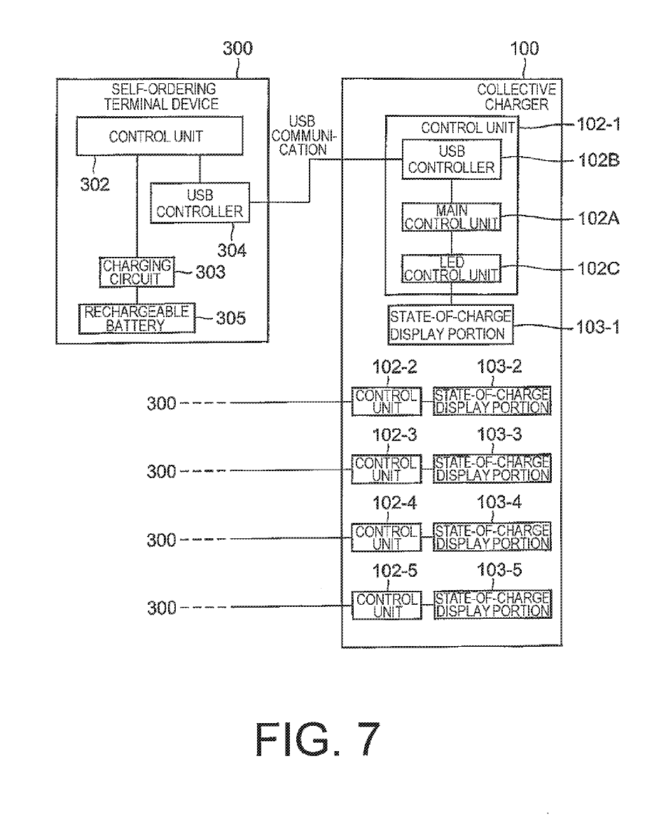

Further, with reference to FIG. 7, each of the control units 102-1 to 102-5 of the collective charger 100 includes a. USB controller 102B configured to perform USB communication, an LED control unit 1020 configured to control the light emission of the state-of-charge display portion 103 having the first to fourth LED indicators 103a to 103d as illustrated in FIG. 5(a), and a main control unit 102A configured to control the USB controller 102B and the LED control unit 102C, In FIG. 7, illustration is made of only the control unit 102-1, however, each of the control units 102-2 to 102-5 similarly includes the USB controller 102B, the LED control unit 1020, and the main control unit 102A.

Meanwhile, as illustrated in FIG. 7, the terminal device 300 includes a USB controller 304 configured to perform USB communication to/from each of the control units 102 of the collective charger 100, a charging circuit 303 configured to charge a built-in rechargeable battery 305 such as a lithium ion battery with the electric power for charging supplied from the collective charger 100, and a control unit 302 configured to detect the remaining battery level of the rechargeable battery 305 by monitoring the charging circuit 303.

The control unit 302 of the self-ordering terminal 300 is configured to control the USB controller 304 to perform USB communication to/from the collective charger 100, to thereby monitor the charging circuit 303 to recognize the state of charge of the battery. Further, the terminal device 300 is configured to monitor and detect the state of charge of the rechargeable battery, to thereby output information indicating the state of charge of the battery to the collective charger 100 through USB communication via the USB controller 304.

[Operation]

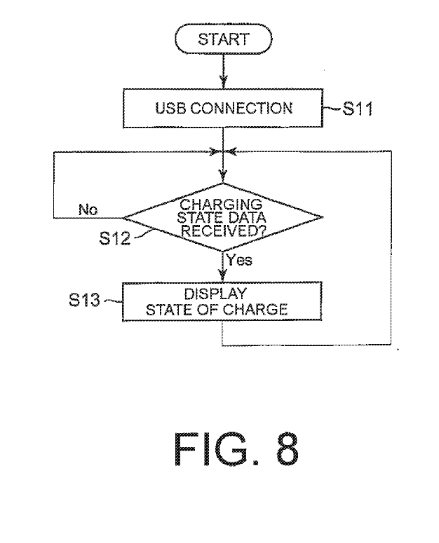

Next, with reference to a flowchart of FIG. 8, description is made of an operation of the control units 102 (102-1 to 102-5) of the collective charger 100 according to the first embodiment of this invention.

First, when the terminal devices 300 are received in the terminal receiving portions 101 (101-1 to 101-5) of the collective charger 100. the receiving detection switches 104 arranged in the respective terminal receiving portions 101 are pushed so that the reset states of the control units 102 are canceled, with the result that the control units 102 start processing.

In Step S11, the collective charger 100 is USB-connected to the terminal device 300 after the control unit 102 starts the processing, and thus the USB communication can be performed between the terminal device 300 and the control unit 102 of the collective charger 100.

Subsequently, in Step S12, the control unit 102 determines whether or not the control unit 102 receives information indicating the remaining battery level regularly transmitted from the terminal device 300. When the control unit 102 receives the information indicating the remaining battery level (Yes in Step S12), the processing proceeds to Step S13. Meanwhile, when the control unit 102 does not receive the information indicating the remaining battery level (No in Step S12), Step S12 is repeated.

Subsequently, in Step S13, each of the state-of-charge display portions 103 (103-1 to 103-5) is controlled to perform display based on the received information indicating the remaining battery level, and the processing returns to Step S12.

In the flowchart of FIG. 8, the information, which indicates the remaining battery level and is regularly transmitted from the terminal device 300, is received at the control unit 102 of the collective charger 100. However, instead of this, the control unit 102 of the collective charger 100 may regularly request the information indicating the remaining battery level to the terminal device 300, to thereby obtain the information.

Here, with reference to FIG. 5(b) for illustrating display examples of the state-of-charge display portions 103 (103-1 to 103-5), in accordance with the information of the remaining battery level obtained from the terminal device 300, the state-of-charge display portions light up as below. In a non-charging state, that is, in a state in which the terminal device 300 is not placed, all of the first to fourth indicators 103a to 103d turn off. In a state in which the remaining battery level is less than 30% during charging, the first indicator 103a lights up in red. In a state in which the remaining battery level is 30% or more and less than 60%, the first and second indicators 103a and 103b light up in red. In a state in which the remaining battery level is 60% or more and less than 90%, the first to third indicators 103a to 103c light up in yellow. In a fully charged state, that is, in a state in which the remaining battery level is 90% or more, the first to fourth indicators 103a to 103d light up in green. Further, in a case where an error such as USB communication error has occurred during processing related to charging state display, the first to fourth indicators 103a to 103d blink in red.

As described above, when all of the first to fourth indicators 103a to 103d turn off, the terminal device 300 is not placed on the collective charger 100. When the terminal device 300 is not placed on the collective charger 100, the control unit 102 is in the reset state, and the LED control unit 102C in the control unit 102 is also reset, with the result that all of the first to fourth indicators 103a to 103d turn off.

In this embodiment, the control unit of the collective charger is in the reset state when the terminal device is not placed, and the reset state of the control unit of the collective charger is canceled when the terminal device is placed. This is in order to prevent in advance a state in Which the collective charger cannot communicate to/from the terminal device after a problem occurs in the control unit of the collective charger due to any factor, for example, a static electricity When the terminal device is not placed. Further, when the collective charger cannot communicate to/from the terminal device even though such countermeasure is taken, the reset and the cancel of the reset of the CPU of the control unit can be carried out through a simple operation in which the terminal device is placed again after being picked up from the terminal receiving portion of the collective charger. As a result, the collective charger can revert to the state of being capable of communicating to/from the terminal device. Without such structure, in order that the collective charger may revert to the state of being capable of communicating to/from the terminal device, a cumbersome operation such as ON/OFF operation of the power source, that is, insertion and removal of the AC adapter is required.

According to the collective charger of this embodiment described above, when the terminal device is placed on the collective charger, the state of the remaining battery level of the terminal device, that is, the remaining battery level is displayed at the state-of-charge display portion arranged in the collective charger. With this portion, the user can visually recognize the state of the remaining battery level, that is, the remaining battery level easily and quickly without viewing a display screen of the terminal device.

Accordingly, there can be prevented a situation in which the staff picks up the terminal device having a small remaining battery level or a further situation in which the staff lends the terminal device which has been picked up to the customer. Thus, a trouble that the terminal device runs out of battery while the customer uses the terminal device does not occur.

Further, there is no need to confirm a state of the battery on the display screen of the terminal device. Thus, the display can be turned off, and this leads to reduction in power consumption and reduction in charging time period.

### Second Embodiment

A second embodiment of this invention is different from the first embodiment in that the number of the control units is one. Therefore, in the same part as or the similar part to the first embodiment, the description and the reference drawings of the first embodiment are incorporated by reference, and the detailed description is omitted.

[Configuration]

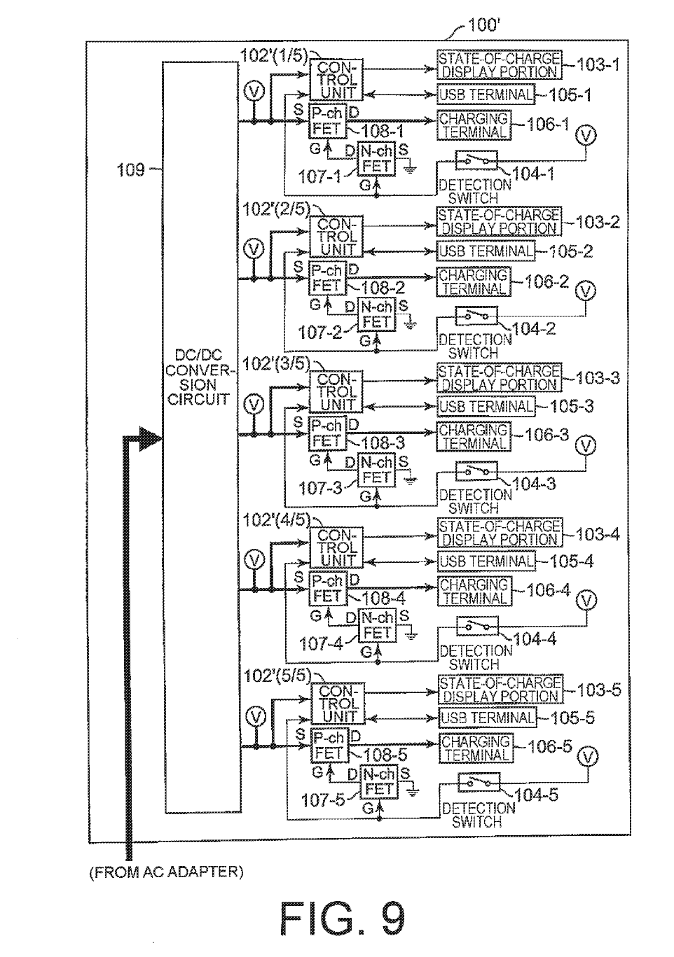

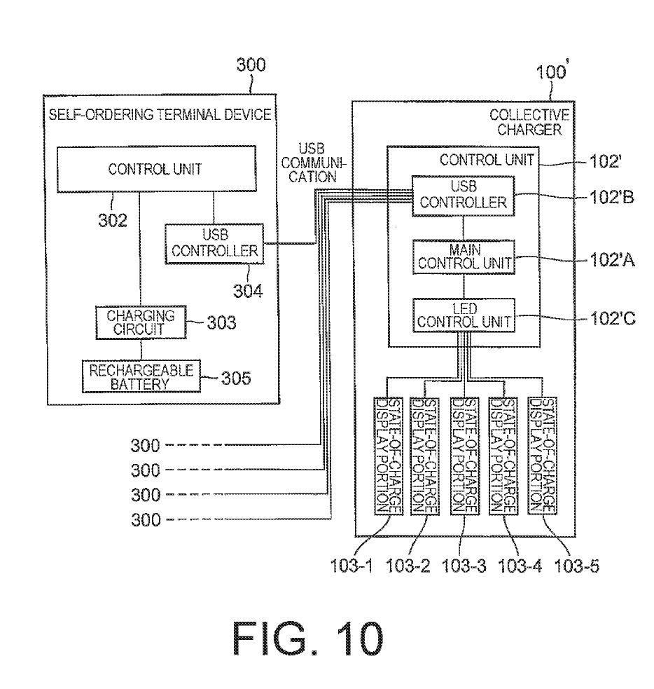

As illustrated in FIG. 9 and FIG. 10, in a collective charger 100′ for a terminal device according to the second embodiment of this invention, a control unit 102′ is not arranged at each of the plurality of terminal receiving portions (not shown), and the number of the control units 102′ is one. In FIG. 9, for the convenience of illustration, illustration is made as if the control unit 102′ is individually arranged at each of the plurality of terminal receiving portions, however, the number of the control units 102′ is one in actuality.

The single control unit 102′ includes a USB controller 102′B configured to perform USB communication to/from each of the five terminal devices 300, an LED control unit 102′C configured to individually control display of the five state-of-charge display portions 103-1 to 103-5, and a main control unit 102′A configured to control the USB controller 102′B and the LED control unit 102′C.

The control unit 102′ further includes a storage unit (not shown) for storing a table which associates the USB terminal to the LED indicator in each of the plurality of terminal receiving portions. With reference to the table, individual acquisition processing of a battery charging state of each of the terminal devices 300 and individual display processing of the state-of-charge display portions 103-1 to 103-5 are carried out.

In the second embodiment, a terminal corresponding to the reset terminal which is used for the cancel of the reset of the control unit of the first embodiment, in which the state is Low when the terminal device 300 is not placed, is used to detect whether or not the terminal device 300 is placed on the terminal receiving portion. In the first embodiment, the control unit is in the reset state when the terminal device is not placed. However, in the second embodiment, the control unit 102′ is in operation and maintains the state irrespective of whether or not the terminal device 300 is placed after the control unit 102′ is initialized when DC power is first supplied from the AC adapter.

[Operation]

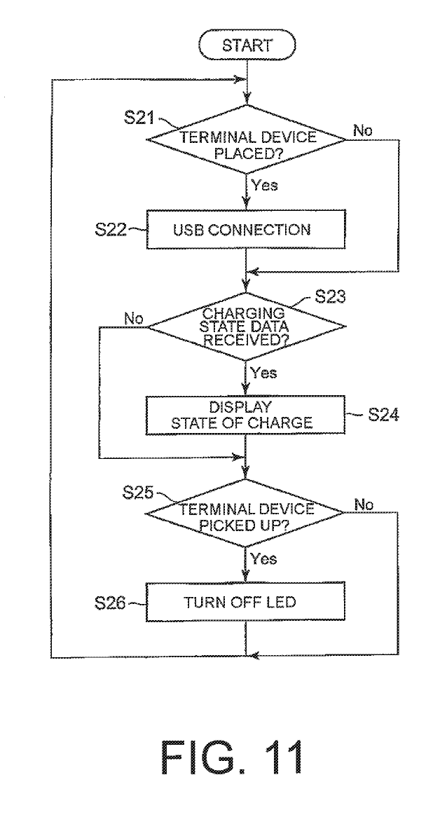

Next, with reference to a flowchart of FIG. 11, description is made of an operation of the control unit 102′ of the collective charger 100′ according to the second embodiment of this invention.

In Step S21, the control unit 102′ determines the presence or absence of the terminal device 300 in each of the plurality of terminal receiving portions based on a detection result of each of the detection switches 104 (104-1 to 104-5). In a case where the detection switch 104 is pushed so that High is input, and thus the control unit 102′ determines that the terminal device 300 is placed (Yes in Step S21), the processing proceeds to Step S22. Meanwhile, in a case where the detection switch 104 is not pushed so that High is not input and Low is maintained, and thus the control unit 102′ determines that the terminal device 300 is not placed (No in Step S21), the processing proceeds to Step S23. This determination is performed on all of the plurality of terminal receiving portions.

Subsequently, in Step S22, the control unit 102′ is USB-connected to the terminal device 300 received in the terminal receiving portion.

In Step S23, the control unit 102′ determines whether or not the control unit 102′ receives information indicating the remaining battery level from the terminal device 300. When the control unit 102′ receives the information indicating the remaining battery level (Yes in Step S23), the processing proceeds to Step S24. Meanwhile, when the control unit 102′ does not receive the information indicating the remaining battery level (No in Step S23), the processing proceeds to Step S25.

In Step S24, the corresponding state-of-charge display portion 103 (103-1 to 103-5) is controlled to perform display based on the received information indicating the remaining battery level.

Subsequently, in Step S25, the control unit 102′ determines whether or not the terminal device 300 placed on the terminal receiving portion is picked up from the terminal receiving portion based on the detection result of the corresponding detection switch 104 (104-1 to 104-5). In a case where the detection switch 104 is not pushed so that High is not input and the state becomes Low, and thus the control unit 102′ determines that the terminal device 300 is picked up (Yes in Step S25), the processing proceeds to Step S26. Meanwhile, in a case where the detection switch 104 is maintained to be pushed and High is input, and thus the control unit 102′ determines that the terminal device 300 is not picked up (No in Step S25), the processing returns to Step S21.

In Step S26, the state-of-charge display portion 103 corresponding to the terminal receiving portion, from which the terminal device 300 is picked up, is brought into an all turn off state, and the processing returns to Step S21.

### Modification Example

In the collective chargers according to the first and second embodiments described above, five terminal devices are receivable. However, the number of terminals to be received can be modified in accordance with an installation space or a power source capacity.

Further, in the first and second embodiments, the USB communication is employed in order to obtain the remaining battery level of the terminal device. However, the communication interface standard may be an interface standard in accordance with a standard mounted to the terminal device. For example, the communication interface standard may be Inter-Integrated Circuit (I2C) communication, or Universal Asynchronous Receiver Transmitter (UART) communication. Alternatively, the communication interface standard may also be an infrared communication or a near field wireless communication.

Further, in the example illustrated in FIG. 5(a), the state of the remaining battery level is displayed by four indicators, however, the number of the indicators can be modified in accordance with the content to be displayed.

Still further, when the LCD is employed as the state-of-charge display portion, a single LCD device for a first terminal receiving portion to a fifth terminal receiving portion, that is, for the first terminal receiving portion to the last terminal receiving portion may serve as the state-of-charge display portion. At a position corresponding to each terminal receiving portion in the single LCD device, the state of the battery capacity of the terminal device placed on the terminal receiving portion may be displayed.

Further, in the case of the collective charger of the type in which the terminal device is horizontally laid and received as in the collective charger illustrated in the drawings of Patent Document 1, the state-of-charge display portion may be arranged around a receiving port for each of the terminal receiving portions.

A part or all of the above-mentioned embodiments are described in the following supplementary notes, but are not limited to the following supplementary notes.

(Supplementary Note 1)

A collective charger, including:

a plurality of terminal receiving portions capable of receiving a plurality of terminal devices, respectively;

a power source unit configured to supply electric power for charging to one or a plurality of terminal devices each received in corresponding one of the plurality of terminal receiving portions; and

a plurality of state-of-charge display portions arranged correspondingly to the plurality of terminal receiving portions, respectively, and each configured to display a state of charge of a battery including a remaining battery level of each terminal device received in a corresponding terminal receiving portion.

(Supplementary Note 2)

A collective charger according to Supplementary Note 1, further including a control unit configured to obtain the state of charge of the battery from the each terminal device received in the corresponding terminal receiving portion, to thereby control corresponding one of the plurality of state-of-charge display portions to display the state of charge of the battery based on the obtained state of charge of the battery.

(Supplementary Note 3)

A collective charger according to Supplementary Note 1 or 2, in which the plurality of terminal receiving portions are formed in parallel to a main body of the collective charger.

(Supplementary Note 4)

A collective charger according to any one of Supplementary Notes 1 to 3, in which each of the plurality of the state-of-charge display portions includes a plurality of LED indicators, and is configured to graphically display the remaining battery level by causing a number of LED indicators corresponding to the remaining battery level to emit light.

(Supplementary Note 5)

A collective charger according to any one of Supplementary Notes 2 to 4, further including:

a plurality of charging terminals arranged correspondingly to the plurality of terminal receiving portions, respectively, and each configured to be electrically connected to a power-receiving terminal arranged on the each terminal device received in the corresponding terminal receiving portion; and

a plurality of USB communication interfaces arranged correspondingly to the plurality of terminal receiving portions, respectively, each of the plurality of USB communication interfaces including a USB terminal and a USB controller and being configured to perform USB communication by being electrically connected to the each terminal device received in the corresponding terminal receiving portion,

in which the power source unit is configured to supply the electric power for charging to the one or the plurality of terminal devices each received in the corresponding one of the plurality of terminal receiving portions through corresponding one of the plurality of charging terminals, and

in which the control unit is configured to obtain the state of charge of the battery from the each terminal device received in the corresponding terminal receiving portion through corresponding one of the plurality of USB communication interfaces.

(Supplementary Note 6)

A collective charger according to any one of Supplementary Notes 1 to 5, in which the power source unit also functions as a power source for the collective charger itself.

(Supplementary Note 7)

A collective charger according to any one of Supplementary Notes 2 to 6, in which the control unit includes control units individually corresponding to the plurality of terminal receiving portions.

(Supplementary Note 8)

A collective charger according to any one of Supplementary Notes 2 to 6,

in which the single control unit is shared by the plurality of terminal receiving portions, and

in which the control unit is configured to individually obtain the state of charge of the battery from the each terminal device received in the corresponding terminal receiving portion, to thereby control the corresponding one of the plurality of state-of-charge display portions, which corresponds to the terminal receiving portion that receives the terminal device for which the state of charge of the battery is obtained, to individually display the state of charge of the battery based on the obtained state of charge of the battery.

(Supplementary Note 9)

A collective charger according to any one of Supplementary Notes 2 to 8, further including a plurality of receiving detection switches arranged correspondingly to the plurality of terminal receiving portions, respectively, and each configured to detect whether or not the corresponding terminal receiving portion receives a terminal device,

in which, based on a detection signal from each of the plurality of receiving detection switches, the control unit brings an operation of the control unit into a reset state when the corresponding terminal receiving portion does not receive the terminal device, whereas the control unit cancels the reset state when the corresponding terminal receiving portion receives the terminal device.

(Supplementary Note 10)

A collective charger according to any one of Supplementary Notes 5 to 9, further including:

a plurality of receiving detection switches arranged correspondingly to the plurality of terminal receiving portions, respectively, and each configured to detect whether or not the corresponding terminal receiving portion receives a terminal device and

a safety circuit configured to prevent voltage of the electric power for charging from being generated by the power source unit in the charging terminal corresponding to the terminal receiving portion in which the terminal device is not received, based on the detection signal from the each of the plurality of receiving detection switches, when the corresponding terminal receiving portion does not receive the terminal device.

(Supplementary Note 11)

A method of charging a terminal device, including the steps of:

receiving one or a plurality of terminal devices, the plurality of terminal devices being arranged in parallel when a plurality of terminal devices are received;

supplying electric power for charging to the received one or plurality of terminal devices; and

displaying a state of charge of a battery including a remaining battery level of each of the received one or plurality of terminal devices at a position corresponding to each terminal device.

### INDUSTRIAL APPLICABILITY

This invention has been described above with reference to the embodiments, but various modifications understandable for a person having ordinary skill in the art may be made to the configurations and details of this invention.

This invention is applicable to, for example, a collective charger to be used in the food service industry, the distribution industry, and the production and logistics fields where a self-ordering terminal device, a service terminal device, a goods management device, and other devices are assumed to be used.

Further, this application is based on and claims the benefit of priority from Japanese Patent Application No. 2014-214210, filed on Oct. 21, 2014, the disclosure of which is incorporated herein by reference in its entirety.

### REFERENCE SIGNS LIST

100, 10′ . . . collective charger
101 (101-1 to 101-5) . . . terminal receiving portion
102 (102-1 to 102-5), 102′ . . . control unit
102A, 102′A . . . main control unit
102B, 102′B . . . USB controller
102C, 102′C . . . LED control unit
103 (103-1 to 103-5) . . . state-of-charge display portion
103a . . . first indicator
103b . . . second indicator
103c . . . third indicator
103d . . . fourth indicator
104 (104-1 to 104-5) . . . receiving detection switch
105 (105-1 to 105-5) . . . USB terminal
106 (106-1 to 106-5) . . . charging terminal
107 (107-1 to 107-5) . . . N channel FET
108 (108-1 to 108-5) . . . P channel FET
109 . . . DC/DC conversion circuit
200 . . . AC adapter
300 . . . self-ordering terminal device (terminal device)
302 . . . control unit
303 . . . charging circuit
304 . . . USB controller
305 . . . rechargeable battery
306 . . . display

1. A collective charger, subjecting a terminal device to charge, the terminal device being shaped in a plate shape, having a first and a second plate surfaces, being provided with a display portion on the first plate surface, being a rechargeable battery-driven type, detecting state of charge of the rechargeable battery, and displaying remaining level of the rechargeable battery on the display portion, the collective charger comprising:
a plurality of terminal receiving portions capable of receiving a plurality of the terminal devices so that the terminal devices are arranged in parallel with the first plate surface and the second plate surface of the adjacent terminal devices opposed to each other, respectively;
a power source unit configured to supply electric power for charging to one or a plurality of terminal devices each received in corresponding one of the plurality of terminal receiving portions;
a plurality of state-of-charge display portions arranged correspondingly to the plurality of terminal receiving portions, respectively, and each configured to display a state of charge of a battery including a remaining battery level of each terminal device received in a corresponding terminal receiving portion; and
a control unit configured to obtain information indicating the state of charge of the battery from the each terminal device received in the corresponding terminal receiving portion, to thereby control corresponding one of the plurality of state-of-charge display portions to display the state of charge of the battery based on the obtained information indicating state of charge of the battery.

2. (canceled)

3. (canceled)

4. The collective charger according to claim 1, wherein each of the plurality of the state-of-charge display portions comprises a plurality of LED indicators, and is configured to graphically display the remaining battery level by causing a number of LED indicators corresponding to the remaining battery level to emit light.

5. The collective charger according to claim 1, further comprising:
a plurality of charging terminals arranged correspondingly to the plurality of terminal receiving portions, respectively, and each configured to be electrically connected to a power-receiving terminal arranged on the each terminal device received in the corresponding terminal receiving portion; and
a plurality of USB communication interfaces arranged correspondingly to the plurality of terminal receiving portions, respectively, each of the plurality of USB communication interfaces comprising a USB terminal and a USB controller and being configured to perform USB communication by being electrically connected to the each terminal device received in the corresponding terminal receiving portion,
wherein the power source unit is configured to supply the electric power for charging to the one or the plurality of terminal devices each received in the corresponding one of the plurality of terminal receiving portions through corresponding one of the plurality of charging terminals, and
wherein the control unit is configured to obtain information indicating the state of charge of the battery from the each terminal device received in the corresponding terminal receiving portion through corresponding one of the plurality of USB communication interfaces.

6. The collective charger according to claim 1, wherein the power source unit also functions as a power source for the collective charger itself.

7. The collective charger according to claim 1, wherein the control unit comprises control units individually corresponding to the plurality of terminal receiving portions,
wherein the collective charger further comprises a plurality of receiving detection switches arranged correspondingly to the plurality of terminal receiving portions, respectively, and each configured to detect whether or not the corresponding terminal receiving portion receives a terminal device, and
wherein, based on a detection signal from each of the plurality of receiving detection switches, the control unit brings an operation of the control unit into a reset state when the corresponding terminal receiving portion does not receive the terminal device, whereas the control unit cancels the reset state when the corresponding terminal receiving portion receives the terminal device.

8. The collective charger according to claim 1,
wherein the single control unit is shared by the plurality of terminal receiving portions, and
wherein the control unit is configured to individually obtain information indicating the state of charge of the battery from the each terminal device received in the corresponding terminal receiving portion, to thereby control the corresponding one of the plurality of state-of-charge display portions, which corresponds to the terminal receiving portion that receives the terminal device for which the information indicating state of charge of the battery is obtained, to individually display the state of charge of the battery based on the obtained information indicating state of charge of the battery.

9. A method of charging a terminal device, the terminal device being an object to be charged, being shaped in a plate shape, having a first and a second plate surfaces, being provided with a display portion on the first plate surface, being a rechargeable battery-driven type, detecting state of charge of the rechargeable battery, and displaying remaining level of the rechargeable battery on the display portion, the method comprising the steps of:
receiving one or a plurality of the terminal devices, a plurality of the terminal devices being arranged in parallel when a plurality of terminal devices are received;
supplying electric power for charging to the received one or plurality of terminal devices;
obtaining information indicating the state of charge of the battery from the each terminal device received in the corresponding terminal receiving portion; and
displaying a state of charge of a battery including a remaining battery level of each of the received the plurality of terminal devices at a position corresponding to each terminal device based on the obtained information indicating state of charge of the battery.

10. The collective charger according to claim 1, further comprising:
a plurality of receiving detection switches arranged correspondingly to the plurality of terminal receiving portions, respectively, and each configured to detect whether or not the corresponding terminal receiving portion receives a terminal device; and
a safety circuit configured to prevent voltage of the electric power for charging from being generated by the power source unit in the charging terminal corresponding to the terminal receiving portion in which the terminal device is not received, based on the detection signal from the each of the plurality of receiving detection switches, when the corresponding terminal receiving portion does not receive the terminal device.
